(19) United States
(12) Patent Application Publication
(10) Pub. No.: US 2021/0049316 A1
(43) Pub. Date: Feb. 18, 2021

(54) MULTI-ELECTRODE ELECTRON EXCITATION BASED SIMULATION METHOD FOR NON-EQUILIBRIUM ELECTRONIC STRUCTURES OF NANODEVICES AND APPARATUS THEREFORE

(71) Applicant: Korea Advanced Institute of Science and Technology, Daejeon (KR)

(72) Inventors: Yong-Hoon Kim, Daejeon (KR); Han Seul Kim, Daejeon (KR); Juho Lee, Daejeon (KR)

(21) Appl. No.: 16/891,602

(22) Filed: Jun. 3, 2020

(30) Foreign Application Priority Data
Jun. 4, 2019 (KR) 1020190065904

(51) Int. Cl. G06F 30/398

(52) U.S. Cl. CPC G06F 30/398

(57) ABSTRACT

A method of simulating a non-equilibrium electronic structure of a nanodevice including receiving region information and applied voltage information of each of a channel, first and second electrodes based on information on first principle and upper approximation method and information on an atomic structure, classifying wave functions generated through the first principle and upper approximation method into each region of the channel, first and second electrodes based on spatial distribution, defining Fermi-Dirac distribution function depending on an electrochemical potential of each of the channel, first and second electrodes based on the classified region information and the applied voltage information, calculating a non-equilibrium electron density using the Fermi-Dirac distribution function corresponding to the region information of each of the channel, first and second electrodes and the wave functions of the classified regions, and acquiring non-equilibrium electronic structure information based on the calculated non-equilibrium electron density, and an apparatus thereof are provided.

### CROSS-REFERENCE TO RELATED APPLICATIONS

A claim for priority under 35 U.S.C. § 119 is made to Korean Patent Application No. 10-2019-0065904 filed on 4 Jun. 2019, in the Korean Intellectual Property Office, the entire contents of which are hereby incorporated by reference.

### BACKGROUND

Embodiments of the inventive concept described herein relate to a technology for computer simulation of a nanodevice in an operating situation, and more specifically, a method of quickly and reliably simulating a non-equilibrium electronic structure of an atomic-level nanodevice and current-voltage characteristics associated therewith, and an apparatus thereof.

A “Hohenberg-Kohn theorem” exists at the basis of the electron density functional theory (DFT), a representative methodology for first-principle electronic structure calculation. The “Hohenberg-Kohn theorem” means that an energy function which mediates electron density, not wave function is minimized based on a variational principle to derive a complex many-electron ground state. A “Kohn-Sham ansatz” is an idea of performing efficient calculations by mapping the many-electron problem to an effective single-particle problem. In performing actual calculations by introducing the “Kohn-Sham ansatz”, the variational principle plays a very important role in securing reliability of the calculations. Therefore, DFT total energy calculation has become a mainstream of the first principle calculation.

Meanwhile, the DFT theory has a constraint that it is applied only to a closed equilibrium system in an equilibrium state basically. Therefore, the DFT theory has difficulty in describing the electronic structure of an open non-equilibrium system, particularly quantum transport characteristics. As the first principle calculation to overcome the constraint, the current DFT-based non-equilibrium Green's function (NEGF) methodology (which calculates and utilizes Hamiltonion and related information first in DFT) is adopted as a standard method. The NEGF methodology is a calculation based on a grand-canonical description and is capable of describing characteristics of a device to which a voltage is applied, as well as a canonical isolated system charged with a fixed charge, through a self-consistent iteration calculation. In fact, over the past decade, many efforts have been made to develop NEGF software based on tight-binding (TB) methodology that converts electronic structures calculated from DFT and DFT into variables.

However, because the NEGF methodology is no longer based on the variational characteristics of the DFT, there is fundamental difficulty in that distribution of electrons (electron density or density matrix) in the channel region and the current derived therefrom are non-variational. Therefore, it is very difficult to check accuracy of calculations because energy cannot be described within the NEGF methodology. In addition, because the electron density is calculated through a correlation function “Gⁿ” in the NEGF methodology, there is a limitation in that it is not possible to directly calculate electron occupancy of non-equilibrium channel region wave functions to provide only constrained information to understand a process of electron transport within a device.

As an alternative to the NEGF calculation, several methodologies are initially considered and some methodologies have been suggested recently, but there is no simulation methodology as powerful as the NEGF methodology yet. For example, recently, although dual mean field approaches, which describe non-equilibrium devices through which current flows in a steady-state state based on equilibrium electron density and non-equilibrium electron density or electron density and current density, have been proposed, there are limitations in that the dual mean field approaches are less accurate than the NEGF calculations or are still non-variational methodologies.

A method of directly applying an applied voltage in the DFT is proposed as another alternative, but both electrodes are processed in separate simulations or interaction between the electrodes or flow of current is not considered. As a result, it is possible to derive power storage characteristics of the system to which the applied voltage is applied, but there is a limitation in that the current cannot be described.

Therefore, for driving characteristics prediction and design of atomic-level device which continues to grow in importance in next-generation device development, there is still a need to develop the first principle non-equilibrium device simulation method, which is capable of calculating nanodevice non-equilibrium electronic structures and IV characteristics without any parameters or approximations.

### SUMMARY

Embodiments of the inventive concept provide a method of simulating an non-equilibrium electronic structure of an electronic device and current-voltage characteristics using the same and an apparatus thereof.

Embodiments of the inventive concept provide a method of simulating an non-equilibrium electronic structure of an electronic device when voltage is applied based on a variational method without any parameters or assumptions and current-voltage characteristics using the same and an apparatus thereof.

According to an exemplary embodiment, a method of simulating a non-equilibrium electronic structure of a nanodevice includes receiving region information and applied voltage information of each of a channel, a first electrode, and a second electrode of the nanodevice based on information on first principle and upper approximation method and information on an atomic structure of the nanodevice, classifying wave functions generated through the first principle and upper approximation method into each region of the channel, the first electrode, and the second electrode of the nanodevice based on a spatial distribution, defining a Fermi-Dirac distribution function depending on an electrochemical potential of each of the channel, the first electrode, and the second electrode based on the classified region information and the applied voltage information, calculating a non-equilibrium electron density of the nanodevice using the Fermi-Dirac distribution function corresponding to the region information of each of the channel, the first electrode, and the second electrode and the wave functions of the classified regions, and acquiring non-equilibrium electronic structure information of the nanodevice based on the calculated non-equilibrium electron density.

The classifying may include generating the wave functions depending on the first principle calculation based on the information on the atomic structure and classifying the generated wave functions into the region of each of the channel, the first electrode, and the second electrode of the nanodevice using coefficients for atomic orbitals included in the generated wave functions.

The defining of the Fermi-Dirac distribution function may include calculating the total number of electrons in a non-equilibrium state based on the Fermi-Dirac distribution function depending on the electrochemical potential of each region defined, calculating a difference between the total number of electrons in the non-equilibrium state and the total number of electrons in an equilibrium state, redefining a Fermi-Dirac distribution function depending on a electrochemical potential of each region when the calculated difference is greater than a predetermined reference difference, and defining a final electrochemical potential and a final Fermi-Dirac distribution function of each region when the calculated difference is less than or equal to the reference difference.

The method of simulating the non-equilibrium electronic structure of the nanodevice may be performed using the first principle calculation and a tight-binding (TB) method based on the first principle.

The acquiring of the non-equilibrium electronic structure information may further include acquiring local electrochemical potential change characteristics of the nanodevice using information on spatial distribution and electron occupancy of the wave function distributed in the channel of the nanodevice.

The acquiring of the non-equilibrium electronic structure information may further include acquiring information on the non-equilibrium electronic structure to which a voltage of the nanodevice is applied by applying an equilibrium first principle calculation analysis method including a band structure or a density of state (DOS).

Furthermore, the method of simulating the non-equilibrium electronic structure of the nanodevice may further include acquiring current-voltage characteristics of the nanodevice including a finite electrode-based nanodevice without additional information on a semi-infinite electrode-based nanodevice and a bulk system corresponding to an electrode based on the acquired non-equilibrium electronic structure information.

The receiving may include additionally receiving region information on an additional electrode including a gate electrode, the classifying may include classifying the wave functions into each region of the channel, the first electrode, the second electrode, and the additional electrode, the defining of the Fermi-Dirac distribution function may include defining a Fermi-Dirac distribution function depending on an electrochemical potential of each of the channel, the first electrode, the second electrode, and the additional electrode, and the calculating of the non-equilibrium electron density may include calculating a non-equilibrium electron density of the nanodevice using a Fermi-Dirac distribution function corresponding to the region information of each of the channel, the first electrode, the second electrode, and the additional electrode and wave functions of the classified regions.

According to an exemplary embodiment, an apparatus for simulating a non-equilibrium electronic structure of a nanodevice includes a receiver that receives region information and applied voltage information of each of a channel, a first electrode, and a second electrode of the nanodevice based on information on first principle and upper approximation method and information on an atomic structure of the nanodevice, an assorter that classifies wave functions generated through the first principle and upper approximation method into each region of the channel, the first electrode, and the second electrode of the nanodevice based on a spatial distribution, a generator that defines a Fermi-Dirac distribution function depending on an electrochemical potential of each of the channel, the first electrode, and the second electrode based on the classified region information and the applied voltage information, a calculator that calculates a non-equilibrium electron density of the nanodevice using the Fermi-Dirac distribution function corresponding to the region information of each of the channel, the first electrode, and the second electrode and the wave functions of the classified regions, and an acquisition unit that acquires non-equilibrium electronic structure information of the nanodevice based on the calculated non-equilibrium electron density.

The assorter may generate the wave functions depending on the first principle calculation based on the information on the atomic structure and classify the generated wave functions into the region of each of the channel, the first electrode, and the second electrode of the nanodevice using coefficients for atomic orbitals included in the generated wave functions.

The generator may calculate the total number of electrons in a non-equilibrium state based on the Fermi-Dirac distribution function depending on the electrochemical potential of each region defined, calculate a difference between the total number of electrons in the non-equilibrium state and the total number of electrons in an equilibrium state, redefine a Fermi-Dirac distribution function depending on a electrochemical potential of each region when the calculated difference is greater than a predetermined reference difference and define a final electrochemical potential and a final Fermi-Dirac distribution function of each region when the calculated difference is less than or equal to the reference difference.

The apparatus for simulating the non-equilibrium electronic structure of the nanodevice may be performed using the first principle calculation and a tight-binding (TB) method based on the first principle.

The acquisition unit may acquire local electrochemical potential change characteristics of the nanodevice using information on spatial distribution and electron occupancy of the wave function distributed in the channel of the nanodevice.

The acquisition unit may acquire information on the non-equilibrium electronic structure to which a voltage of the nanodevice is applied by applying an equilibrium first principle calculation analysis method including a band structure or a density of state (DOS).

The acquisition unit may acquire current-voltage characteristics of the nanodevice including a finite electrode-based nanodevice without additional information on a semi-infinite electrode-based nanodevice and a bulk system corresponding to an electrode based on the acquired non-equilibrium electronic structure information.

The receiver may additionally receive region information on an additional electrode including a gate electrode, the assorter may classify the wave functions into each region of the channel, the first electrode, the second electrode, and the additional electrode, the generator may define a Fermi-Dirac distribution function depending on an electrochemical potential of each of the channel, the first electrode, the second electrode, and the additional electrode, and the calculator may calculate a non-equilibrium electron density of the nanodevice using a Fermi-Dirac distribution function corresponding to the region information of each of the channel, the first electrode, the second electrode, and the additional electrode and wave functions of the classified regions.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a flowchart illustrating a method of simulating a non-equilibrium electronic structure of a nanodevice according to an embodiment of the inventive concept;

FIG. 2 is a flowchart illustrating an embodiment for describing the method of FIG. 1;

FIGS. 3A and 3B illustrate a schematic diagram of an electronic structure change and an exemplary diagram for a specific operation method according to the application of a method of the inventive concept;

FIG. 4 is a flowchart illustrating a process of acquiring electrode-based current-voltage characteristics of each of infinite and finite dimensions using a method of the inventive concept;

FIGS. 5A to 5C illustrate an exemplary diagram for analysis of non-equilibrium energy and atomic force through a calculation result by a method of the inventive concept;

FIGS. 6A to 6C illustrate an exemplary diagram for a method of calculating an electrochemical potential change (quasi-Fermi level profile) using electron occupancy information of an energy level (or wave function) distributed in a channel according to a method of the inventive concept;

FIGS. 7A and 7B illustrate an exemplary diagram in which an electronic structure in a non-equilibrium state is capable of being described using conventional DFT-based analysis techniques by applying a method of the inventive concept to a two-dimensional stacked nanodevice;

FIGS. 8A to 8C illustrate an exemplary diagram of an non-equilibrium electronic structure and current-voltage characteristics in a two-dimensional stacked device based on a finite dimensional electrode to which a voltage is applied by applying a method of the inventive concept;

FIG. 9 illustrates a configuration of an apparatus for simulating a non-equilibrium electronic structure of a nanodevice according to an embodiment of the inventive concept; and

FIGS. 10 to 10C illustrate an exemplary diagram for a technical description embodiment of a multi-electrode using MS-DFT proposed by the inventive concept and a method thereof.

### DETAILED DESCRIPTION

Advantages and features of the inventive concept, and methods for achieving them will be apparent from the following embodiments that will be described in more detail with reference to the accompanying drawings. However the inventive concept is not limited to the following embodiments and may be implemented in various forms. In addition, the embodiments complement the disclosure of the inventive concept and are provided for a person skilled in the art to fully understand the scope of the inventive concept, and the inventive concept is defined only by the appended claims.

The terms are only used to describe embodiments and not to limit the scope of the inventive concept. Herein, the singular forms are intended to include the plural forms as well, unless the context clearly indicates otherwise. The terms “comprises” and/or “comprising”, when used herein, specify the presence of stated features, integers, steps, operations, and/or components, but do not preclude the presence or addition of one or more other features, integers, steps, operations, and/or components.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, embodiments of the inventive concept will be described in detail with reference to the accompanying drawings. Like reference numerals refer to like elements throughout, and also, their detailed descriptions will be omitted.

The inventive concept relates to science and engineering simulation technology, and in particular, provides a first principle calculation methodology for atomic-level nanodevice characteristic design, which is a major growth engine in recent electronic computational-aided design (ECAD or technology computer-aided design, TCAD) market.

The inventive concept proposes a multi-space constrained-search density functional theory (MS-DFT) as a novel first principle calculation method capable of predicting a non-equilibrium electronic structure, non-equilibrium state energy/force, and quantum charge transport characteristics of a nanodevice.

The inventive concept introduces viewing quantum transport phenomenon, that occurs when voltage is applied to a source and a drain, or a gate electrode as needed, as mapping multi-spatial (from a drain electrode to a source electrode) electron excitation instead of the conventional Landauer approach. Accordingly, an electronic structure of a device under the applied voltage may be variationally calculated by applying a micro-canonical constrained-search density functional theory (DFT) and a matrix Green's function (MGF) is calculated after the electronic structure of the device is calculated to derive transport characteristics. Thus, the efficiency and accuracy of calculation may be secured in performing atomic-level ECAD, compared to the existing DFT-based non-equilibrium Green's function (NEGF) methodology, and in particular, it is possible to overcome constraints of the existing DFT-NEGF methodology, such as providing non-equilibrium energy/atomic force information and describing a finite-dimensional electrode.

In the inventive concept, the number of electrodes of the nanodevice may be expanded to two or more.

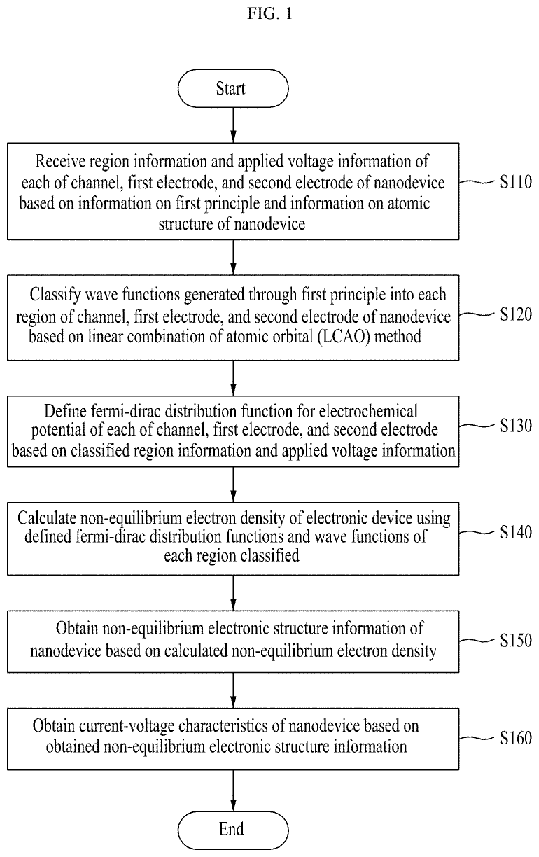

FIG. 1 is a flowchart illustrating a method of simulating a non-equilibrium electronic structure of a nanodevice according to an embodiment of the inventive concept.

Referring to FIG. 1, in a method according to an embodiment of the inventive concept, region information and applied voltage information of each of a channel, a first electrode, and a second electrode of a nanodevice is received based on information on existing first principle and upper approximation method and information on an atomic structure of the nanodevice in S110.

Here, the information on the atomic structure may include all information on the atomic structure of the inventive concept, such as information on an atom itself, information on an atomic structure, and electronic information on the atom.

Here, region information on an additional electrode, such as gate electrode, may be further received in S110.

When various information is received through S110, wave functions generated through the existing first principle and upper approximation method are classified into regions of the channel, the first electrode, and the second electrode, or the additional electrode as needed based on a spatial distribution method, for example, a linear combination of atomic orbital (LCAO) method, and a Fermi-Dirac distribution function depending on electrochemical potential of the channel, the first electrode, and the second electrode or the additional electrode as needed is generated based on the classified region information and applied voltage information in S120 and S130.

Here, in S120, the wave functions may be generated depending on the first principle calculation based on the information on the atomic structure, and the wave functions generated in a self-consistent field (SCF) loop may be classified into the region of each of the channel, the first electrode, and the second electrode of the nanodevice or the additional electrode as needed using coefficients for atomic orbitals included in the generated wave functions, for example, coefficients for linear bonds of atomic orbitals.

Here, calculating the total number of electrons in a non-equilibrium state based on a Fermi-Dirac distribution function in accordance with the electrochemical potential of each region defined above, calculating a difference between the total number of electrons in the non-equilibrium state and the total number of electrons in an equilibrium state, re-defining a Fermi-Dirac distribution function depending on the electrochemical potential of each region when the calculated difference is greater than a predetermined reference difference, and defining an electrochemical potential and a Fermi-Dirac distribution function of each final region when the calculated difference is less than or equal to the reference difference may be further included in S130.

Non-equilibrium electrode density of the nanodevice is calculated using the Fermi-Dirac distribution function depending on the electrochemical potential and the wave functions of each classified region of the channel, the first electrode, and the second electrode or the additional electrode as needed in S140 and S150 when the Fermi-Dirac distribution function depending on the electrochemical potential of each of the channel, the first electrode, and the second electrode or the additional electrode as needed is generated in S120.

Here, the difference between the calculated non-equilibrium electron density and the previously calculated non-equilibrium electron density may be calculated in S140 and operations S120 to S140 may be repeatedly performed using the calculated non-equilibrium electron density when the difference between the calculated non-equilibrium electron density and the previously calculated non-equilibrium electron density is greater than the predetermined reference difference, and the calculated non-equilibrium electron density in a related range may be calculated as a final non-equilibrium electron density when the difference between the calculated non-equilibrium electron density and the previously calculated non-equilibrium electron density is less than the reference difference.

Further, in S150, local electrochemical potential change characteristics of the nanodevice may be acquired using spatial distribution and electron occupancy information of the wave function distributed in the channel of the nanodevice, and information on the non-equilibrium electronic structure when a voltage is applied to the nanodevice may be acquired by applying a first principle calculation analysis method of equilibrium including band structure or density of states (DOS).

The non-equilibrium electronic structure information acquired in S150 may include a result of the first principle calculation of the nanodevice, non-equilibrium electron density, total energy, eigenstates, that is, wave functions, eigenvalues, quasi-Fermi level, non-equilibrium steady state, Hamiltonian, overlap matrix, electron density matrix, and the like.

When the non-equilibrium electronic structure information of the electronic device is acquired in S150, current-voltage characteristics of the electronic device are acquired based on the acquired non-equilibrium electronic structure information in S160.

Here, in step S160, a retardation Green's function may be derived based on the acquired non-equilibrium electronic structure information, a transmission function is calculated based on the derived retardation Green's function, and the calculated transmission function may be applied to a Landauer formula to obtain the current-voltage characteristics of the nanodevice.

Here, in S160, the current-voltage characteristics of a finite electrode-based nanodevice may be acquired based on the acquired non-equilibrium electronic structure information without additional information on the semi-infinite electrode-based nanodevice and the cluster system related to the electrode.

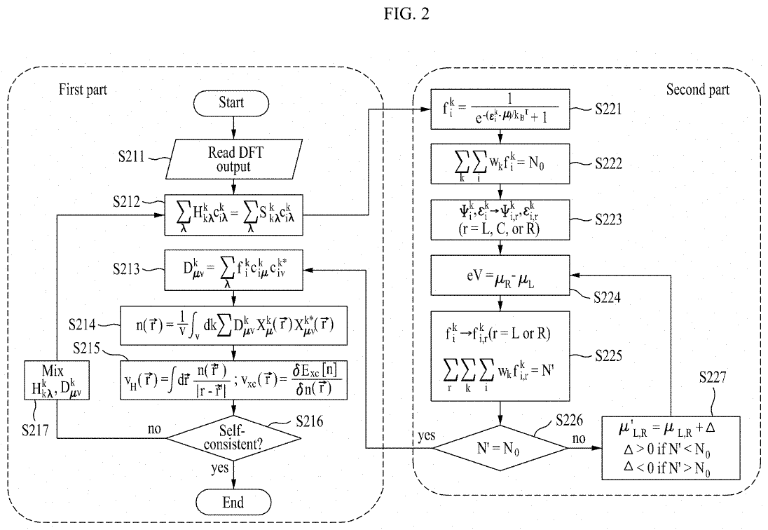

A method for the inventive concept will be described in detail with reference to FIGS. 2 to 8.

FIG. 2 is a flowchart illustrating an embodiment for describing the method of FIG. 1. In addition, as illustrated in FIG. 2, the method according to the inventive concept includes a first part performed by the existing first principle calculation method and a second part newly presented in a method of the inventive concept, and the description will be divided into the first part and the second part as follows.

First, the first part will be described. Information on the existing first principle-based calculation and the atomic structure (Cartesian coordination in xyz format) of an electronic device, for example, a nanodevice, and atomic information (e.g., atomic type C , H, O, N, etc.), applied voltage, and region information for both electrodes and channel are received as inputs.

In S211, an existing equilibrium DFT calculation result is derived through the existing first principle-based calculation method, for example, the density functional theory (DFT) calculation. For example, when an electron density matrix “D” is designated as an initial value, the result of the existing equilibrium DFT calculation may be quickly derived, but the initial value may be selectively determined. Here, minimum information required for DFT calculation may include an exchange-correlation function type, number of basis, k-point, and the like, and detailed descriptions thereof will be omitted because these details are known to those skilled in the art.

In S212, an equation expresses a Schrodinger equation in matrix form, where “H” and “S” denote Hamiltonian and overlap matrix for each k point.

Here, the k-point is a concept from solid-state physics when trying to describe an infinite system as a unit cell, a basic concept of the k-point may mean that it is not possible to describe an infinitely repetitive material in a finite real space, but when the finite real space is converted into a momentum space (k-space), the electronic structure and energy may be defined through point sampling in first Billouin zone (FBZ) defined in the momentum space of the unit cell.

“D” in S213 denotes an electron density matrix, and is expressed as a square of a wave function composed of a Fermi-Dirac distribution “f ” and LCAO for each k point. Here, “μ.” and “v” may denote basis indexes and may mean a basis index of a number of atoms.

LCAO is defined as in <Equation 1> below.

$${ψ}_{i} ( r ) = {\sum }_{μ} {χ}_{μ} ( r ) {c}_{μ i} \qquad [ Equation 1 ]$$

Here, “ψ” means “i-th” wave function, the “i-th” wave function is defined as a linear summation in which an atomic orbital (or basis) “χ” is multiplied by a coefficient “c”, and “μ” is a basis index.

Here, Equation 1 satisfies orthogonality, and therefore the following <Equation 2> may be satisfied.

c_{μi}=<χ_{μ}|ψᵢ> [Equation 2]

Therefore, an equation for finding an eigenvalue in a form of a matrix is established.

In S214, “n(r)” may denote an electron density function and a density function in real space may be acquired by squaring the density matrix “D” by the basis “χ(r)”. Here, “V” may mean volume of a system.

In S215, two potentials are calculated with the acquired electron density “n(r)”. A left equation is the Hartree potential “V_{H}”, which is accepted as an electrostatic potential, and is expressed as the Coulomb potential formula, but is applied with a Poisson equation in an actual DFT code. Therefore, in the equation, a distance “r” vector is entered in a denominator and an electrostatic potential between a density at an “r′” point and a density at an “r” point is calculated. A right equation is a so-called exchange-correlation function, which is calculated by approximating exchange energy between electrons and correlation energy as a function of the electron density “n(r)”.

In step S216, a novel Hamiltonian, that is, a Hartley potential and an electron density matrix, acquired through a current loop is compared with a previous Hamiltonian acquired through a previous loop, and when the compared value is a specific reference tolerance, calculation is terminated. Otherwise, operation S217 is performed.

Here, in S216, when the compared value is less than the specific reference tolerance, a calculation result of the first principle of the electronic device, an electron density function, a total energy, eigenstates, that is, wave functions, an eigenvalue, a Fermi level, a Hamiltonian, overlap matrix, electron density matrix, and the like are provided or acquired.

In S217 (mixing), an arbitrary variational is given to each matrix, thereby helping convergence of the entire calculation.

Here, a Hamiltonian operator may be an operator that calculates energy of an entire system and may consist of kinetic energy and potential energy (e.g., exchange-correlation potential, Hartley potential). When the Hamiltonian is solved, the total energy may be acquired, a Schrodinger equation may be proved to be calculated variably to describe an exact value of a ground state and free energy and enthalpy measurable in a real experiment may be converted and used based on the above.

The second part which is a core concept of the inventive concept will be described. In S221, a Fermi-Dirac distribution “f” is defined based on a chemical potential (or Fermi level) “ρ” in an equilibrium state. Here, “i” and “k” may denote a wave function number and “k” point, respectively, “ε” may denote an intrinsic value, “k_{B}” may denote a Boltzmann constant, and “T” may denote a temperature.

In S222, when the Fermi-Dirac distribution and a weight factor “w” at each “k” point are multiplied and summed, the total number of electrons “N₀” in a equilibrium state may be acquired.

In S223, a wave function, that is, an intrinsic state “ψᵢ”, and an intrinsic value “εᵢ” corresponding thereto, is classified into a first electrode region, a channel region, and a second electrode region of the electronic device through a predetermined specific reference.

Here, the specific reference may be as illustrated in <Equation 3> below.

$${ψ}_{i} ∈ \{ \begin{matrix}L if {\int }_{L} {\vert {ψ}_{i} ( r ) \vert}^{2} {d}^{3} r > {\int }_{C \text{/} R} {\vert {ψ}_{i} ( r ) \vert}^{2} {d}^{3} r , \\ C if {\int }_{C} {\vert {ψ}_{i} ( r ) \vert}^{2} {d}^{3} r > {\int }_{L \text{/} R} {\vert {ψ}_{i} ( r ) \vert}^{2} {d}^{3} r , \\ R if {\int }_{R} {\vert {ψ}_{i} ( r ) \vert}^{2} {d}^{3} r > {\int }_{C \text{/} L} {\vert {ψ}_{i} ( r ) \vert}^{2} {d}^{3} r .\end{matrix} \qquad [ Equation 3 ]$$

A corresponding region is designated as an input and wave functions are classified into each region through magnitude comparison based on the sum of squares of the LCAO coefficients of the atomic index. Equation 3 is described as a wave function and as described above, the LCAO-based wave function is expressed as a linear summation of the basis and coefficients.

In step S224, the applied voltage V defined as an input is provided to be defined as a chemical potential “μ_{L}” of a left electrode, for example, the first electrode, and a chemical potential “μ_{R}”, of a right electrode, for example, the second electrode. Here, each chemical potential may be defined as illustrated in <Equation 4> below to match charge neutrality of the entire system. A common computational simulation introduces repetitive boundary conditions to deal with a large system within a confined grid box. When the charge neutral condition is not met or a specific boundary condition is not introduced, the system is diverged.

$${μ}_{L \text{/} R} = μ \pm \frac{eV}{2} \qquad [ Equation 4 ]$$

In S225, a Fermi level (electrochemical potential) of each region is defined and a Fermi-Dirac distribution depending on the Fermi level is defined. Then, the number of electrons “N”' in the non-equilibrium state is calculated through the weight factor and the Fermi-Dirac distribution for each region, “k” and wave function number “i”.

In S226, when a difference between values of “N′” and “N₀” satisfies a predetermined condition, that is, when the difference between the two values is within a specific difference, the process returns to the first part and proceeds to calculating the electron density matrix. On the other hand, when the difference between the values of “N′” and “N₀” does not satisfy the specific condition, the Fermi level is readjusted through S227 to calculate the number of electrons in the non-equilibrium state.

Accordingly, a brief summary of the method according to the inventive concept is as follows.

The inventive concept introduces an external applied voltage effect by taking the electronic structure of an equilibrium state as an initial condition, and when using a local basis function, each Con-Sham orbital is indexed within not only an energy space, but also a position space to classify orbitals based thereon. In detail, when a KS orbital is described as a linear combination of atomic orbital (LCAO), the first electrode region, the channel region, and the second electrode region are classified based on the magnitude of the coefficient multiplied by the basis of each atomic orbital. In addition, the applied voltage “V” is defined as the difference in the electrochemical potential of each electrode, V=(μL−μR)/e, and the KS orbitals classified by region fill electrons based on the electrochemical potential “mica” of each region using the Fermi-Dirac distribution function. Further, the number of electrons “N”' of the non-equilibrium system should always be maintained as the initial number of electrons “N₀” based on a micro-canonical description and the above process is inside a general electronic structure calculation algorithm that follows the variational principle. Therefore, it is designed so that an non-equilibrium electronic structure is acquired variably and simultaneously, an accurate energy value is calculated.

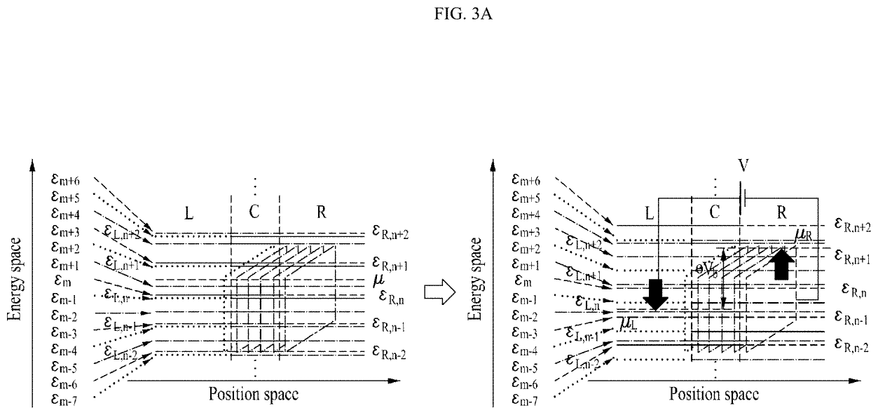

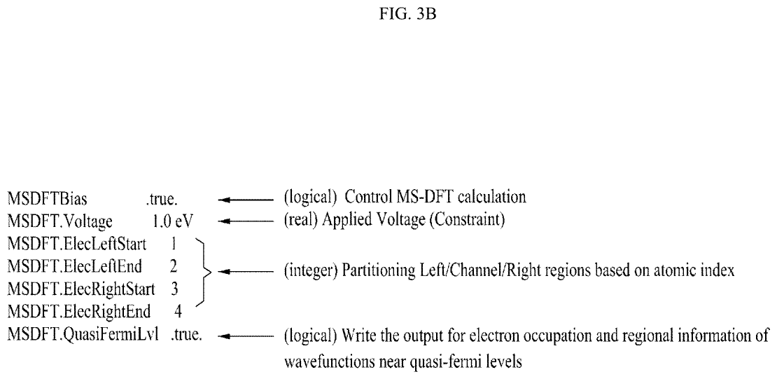

FIGS. 3A and 3B illustrate a schematic diagram of an electronic structure change and an exemplary diagram for a specific operation method according to the application of a method of the inventive concept. FIG. 3A illustrates a schematic diagram of an electronic structure change by application of MS-DFT and FIG. 3B illustrates a detailed operation method.

As illustrated in FIG. 3A, each wave function is indexed in the energy space and the position space according to a wave function technology of the LCAO in a left drawing of a state in which no voltage is applied. As illustrated in a right drawing, when voltage is applied, the applied voltage “V_{b}” is expressed as a difference of electrochemical potential of each electrode V_{b}=(μ_{L}−μ_{R})/e. According to the process of FIGS. 1 and 2, the energy change of the wave functions resulting from the each region of left electrode/channel/right electrode (L/C/R) occurs.

As illustrated in FIG. 3B, the inventive concept may be implemented by an open source, for example, SIESTA code, and thus an MS-DFT code execution method is the same as an existing SIESTA code execution method but additional variables need to be set. As the additional variational setting for MS-DFT calculation, constrained voltage (MSDFT.Voltage), atomic indices for dividing the electrode and channel regions (MSDFT.ElecLeft and MSDFT.ElecRight), and electron occupation output setting corresponding to each final wave function may be included. The method according to the inventive concept may be implemented with other open sources.

A further description of the inventive concept is as follows.

### Formulation of MS-DFT in Steady-State Quantum Transport

The inventive concept establishes a multi-space constrained search DFT formalism as follows.

Step 1 (micro-canonical perspective): First, in the inventive concept, when a grand canonical or Landauer picture is converted to a micro-canonical picture, current is large, but it may be viewed as a long-term discharge of a finite capacitor. This approach was initially searched by Di Ventra and Todory (M. Di Ventra and TN Todorov, Transport in Nanoscale Systems: The Microcanonical Versus Grand-Canonical Picture, J. Phys. Condens. Matter 16, 8025 (2004). However, they focused on studying transition electron mechanics in combination with the time-dependent DFT rather than the steady state. The inventive concept focuses on the steady state quantum transport issue.

Step 2 (division): In the inventive concept, a junction is divided into left electrode “L”, channel “C”, and right electrode “R” regions, and the spatial origin of the wave function “Ψ” is traced to “L” or “C” or “R”. At a zero-bias constraint, a ground state density ρ₀(\vec{r})=ρ₀^{L}(\vec{r})+ρ₀^{C}(\vec{r})+ρ₀^{R}(\vec{r}) is collectively given with one global Fermi level. “L”/“C”/“R” division may be similar to that introduced in standard DFT-NEGF calculations and may be physically justified by Kohn's “nearsightedness” principle. The exponential decay of the single particle density matrix is particularly guaranteed in insulators and semiconductors, and the inventive concept assumes that a semiconductor (or insulator) region is provided in the “C”. The inventive concept may also be a metallic channel. The “L” and “R” regions corresponding to the bulk left and right electrodes are assumed to be metal, respectively, the density matrix of the metal decreases logarithmically at 0 degrees, and the “L” and “R” regions are physically separated by the semiconductor regions in the “C”.

Step 3 (optical analogy): Finally, in the inventive concept, a finite applied bias voltage Vb=(μR−μL)/e may be seen as excitation from states spatially belonging to the drain electrode “L” to states spatially belonging to the source electrode “R”. Here, “μR(μL)” may mean the chemical potential of the region “R(L)”, and a constrained search may be applied to spatially excited states with a density “ρₖ”. That is, the inventive concept establishes the mapping of transport issue to an optical one, and generalizes the variational (or time independent) excitation-state DFT established by the conventional technique to the multi-space such as the drain electrode to the source electrode excitation case. In other words, the role of light in the time-independent DFT may be performed by an external battery in the MS-DFT, and may be mathematically implemented by multi-space constraint.

Then, given the ground state of the total energy “E₀” and the density “p₀”, a governing equation of MS-DFT may become a constrained search of the total energy minimum value of the excited state with a density ρₖ(\vec{r})=ρₖ^{L}(\vec{r})+ρₖ^{C}(\vec{r})+ρₖ^{R}(\vec{r}) and may be expressed as in <Equation 5> below, and a universal function may be expressed as in <Equation 6> below.

$$\begin{matrix}{E}_{k} = {min}_{ρ} \{ \int v ( \vec{r} ) ρ ( \vec{r} ) {d}^{3} \vec{r} + F [ {ρ}_{k}^{L} , {ρ}_{k}^{C} , {ρ}_{k}^{R} , {ρ}_{0} ] \} = \int v ( \vec{r} ) ρ ( \vec{r} ) {d}^{3} \vec{r} + F [ {ρ}_{k} , {ρ}_{0} ] & [ Equation 5 ] \\ F [ {ρ}_{k} , {ρ}_{0} ] = {min}_{{Ψ}^{L \text{/} C \text{/} R} \to {ρ}_{k}} 〈 {Ψ}^{L \text{/} C \text{/} R} \vert \hat{T} + {\hat{V}}_{ee} \vert {Ψ}^{L \text{/} C \text{/} R} 〉 & [ Equation 6 ]\end{matrix}$$

Here, the spatially-resolved “Ψ^{L/C/R}” may be understood to be restricted to the states that satisfy the bias constraint “eV_{b}=μ_{R}−μ_{L}” and are orthogonal to the first “k−1” excited states.

In the inventive concept, by solving the corresponding single electrode Kohn-Sham (KS) equation illustrated in <Equation 7>, “ρk” and “Ek” may be acquired with the constraint of “eV_{b}=μ_{R}−μ_{L}”.

[ĥ_{KS}⁰+Δv_{Hxc}(\vec{r})]ψᵢ(\vec{r})=εᵢψᵢ(\vec{r}) [Equation 7]

Here, and ĥ_{KS}⁰, Δv_{Hxc}(\vec{r}), ψ(\vec{r}), and “εᵢ” may indicate a ground state KS Hamiltonian, a bias-induced modification of the KS potential, KS eigenstates, and KS eigenvalues, respectively.

Step 4 (transmission): Within DFT-NEGF, the matrix elements of the electrode regions are replaced by the matrix elements of separate bulk calculations(fracture boundary condition) in the process of constructing the self-energy Σ_{l(R)}=x_{L(R)}g_{S}^{L(R)}x_{L(R)}⁵⁵⁴ by the Landauer point of view. Here, “X_{L(R)}” may refer to an “L-C(C-R)” coupling matrix and “gₛ^{L(R)}” may refer to an “L(R)” surface Green's function. This replacement directly affects the finite-bias self-consistency cycle for computing the density matrix in DFT-NEGF, and actual difficulties may already appear in the finite bias non-equilibrium electronic structure calculation operation because there is no variational principle.

Meanwhile, the inventive concept eliminates the scattering boundary condition within the MS-DFT, does not introduce information acquired from a separate bulk crystal calculation or “Σ_{R(L)}”, and completes the self-consensus cycle for the solution of the non-equilibrium KS equation. Instead, after acquiring the non-equilibrium electronic structure completely, matrix Green's function formalism is called, and the transmission function is calculated to perform the post-processing operation. Here, the transmission function for the non-equilibrium electronic structure may be expressed as illustrated in <Equation 8> below.

T(E; V_{b})=Tr[Γ_{L}GΓ_{R}G^{†}] [Equation 8]

Here, may mean a retarded Green's function, and Γ_{L(R)}=i(Σ_{l(R)}−Σ_{l(R)}^{†}) may mean an “L(R)” electrode-induced broadening matrix.

Then, a Landauer-Buttiker formula may be called to obtain current-bias voltage (I-V_{b}) characteristics, and the current bias voltage characteristics may be expressed as illustrated in <Equation 9> below.

$$I ( {V}_{b} ) = \frac{2 e}{h} {\int }_{{μ}_{L}}^{{μ}_{R}} T ( E ; {V}_{b} ) [ f ( E - {μ}_{R} ) - f ( E - {μ}_{L} ) ] dE \qquad [ Equation 9 ]$$

Here, f(E−μ)=1/{1+e(E−μ)/kBT}} may mean a Fermi Dirac distribution function.

### Novel Characteristics and Implementation of MS-DFT

Some comments are as follows.

First, in regard to the mapping from transport to excitation, which is important three steps, the inventive concept emphasizes that it is called from the viewpoint of being able to formulate MS-DFT similar to the scattering boundary condition in the Landauer picture for DFT-NEGF. Here, this picture may reproduce the electronic structure generated by DFT-NEGF well.

Next, in regard to the “L”/“C”/“R” division which is step 2, it may be expected that the physically distinctive metallic electrode/semiconducting channel interface is in “C” and the unambiguous assignment of “ψᵢ” to the “L”/“C”/“R” region is guaranteed at a sufficient level of decoupling between “L” and “R” states. The identification of localized “ψᵢ” near “C” may generally be achieved based on the construction of the Wannier function, and thus the spatial assignment of “ψᵢ” should be possible in principle regardless of the selection of the basis sets. In practice, the inventive concept may implement MS-DFT within SIESTA code, which is based on a linear combination of atomic orbital formalism and extensively employed for DFT-NEGF program development.

Finally, with respect to transmission calculation which is step 4, the natural advantage of MS-DFT over DFT-NEGF may naturally treat a finite electrode such as single-layer graphene in a vertical van der Waals (vdW) heterostructure configuration as the micro-canonical formalism. Here, the inventive concept may calculate the finite bias transmission using <Equation 10> below.

T(E; V_{b})=Tr[a_{L}Ma_{R}M^{†}] [Equation 10]

Here, “a_{L(R)}” may mean a spectral function of an L(R) contact, and may mean M=x_{L}^{†}Gx_{R}.

When calculating “a_{l(R)}”, because there are no more infinitely repeating electrode unit cells for the physically finite electrode case, the surface Green's function “gₛ^{L(R)}” is replaced with the region “L(R)” Green's function “G” calculated from the junction model. Here, in the inventive concept, a constant expansion factor, which enters into the construction of “gₛ” for the semi-infinite electrode case and physically represents the nature of electrons incoming from the source electrode or the electrons outgoing into the drain electrode, may be introduced. The matrix element M approximately corresponds to the tunneling matrix of the Bardeen transfer Hamiltonian approach, but properly accepts the impact of coupling between the channel and electrodes and their atomistic details.

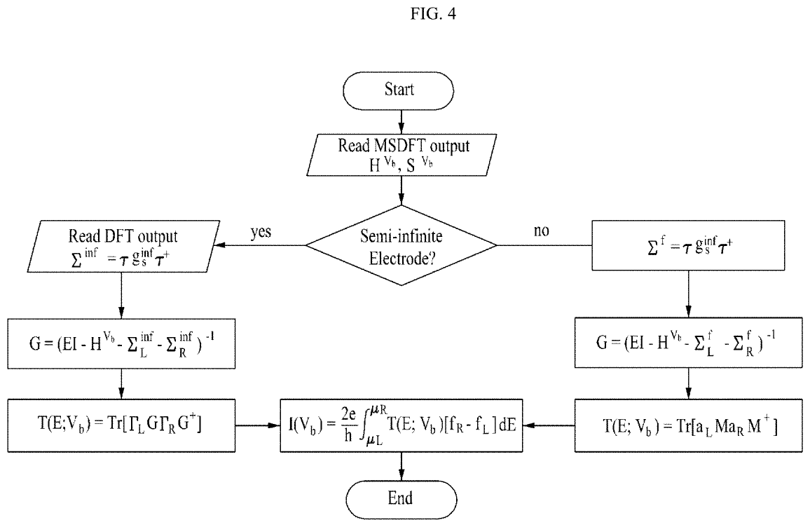

FIG. 4 is a flowchart illustrating a process of acquiring electrode-based current-voltage characteristics of each of infinite and finite dimensions using a method of the inventive concept. As illustrated in FIG. 4, the non-equilibrium Hamiltonian and the overlap matrix among the non-equilibrium electronic structure information acquired through FIG. 2 are received as input variables and it is determined whether the electrode of the electronic device is a semi-infinite electrode or a finite electrode based on the previously input electrode information.

Here, since the semi-infinite electrode is known to those skilled in the art, a detailed description thereof will be omitted, and the finite electrode may refer to an electrode other than the semi-infinite electrode as a finite electrode.

When the electrode of the electronic device is an semi-infinite electrode, the existing DFT calculation for the electrode mass system is additionally performed by mathematically utilizing the characteristics that the solid unit grid is infinitely repeated to derive the surface Green's function “gₛ” therethrough, the derived “gₛ” and the interaction term are acquired to calculate the self-energy “Σ”, and including the self-energy, the retarded Green's function “G” is calculated for each energy E. The transmission function T(E; Vb) is calculated using the derived G, the calculated transmission function is applied to the Landauer formula to calculate the terminal current depending on the voltage, thereby acquiring the current-voltage characteristics of the electronic device using the semi-infinite electrode.

On the other hand, when the electrode of the electronic device is a finite electrode, “L(R)” of the region corresponding to the electrode within the Hamiltonian “H^{vb}” to which the voltage is applied and the Green's function “G” replaces the surface Green's function “gsL(R)” without additional DFT calculation, the interaction term between the channel and the finite electrode is calculated based thereon to calculate the self-energy “Σ”, and the retardation Green's function is calculated for each energy “E” including the self-energy “Σ”. The spectral function a =GFGt is derived based on the derived “G” to calculate the transmission function and the calculated transmission function is applied to the Landauer formula to calculate the terminal current depending on the corresponding voltage, thereby acquiring the current-voltage characteristics of the electronic device using the finite electrode.

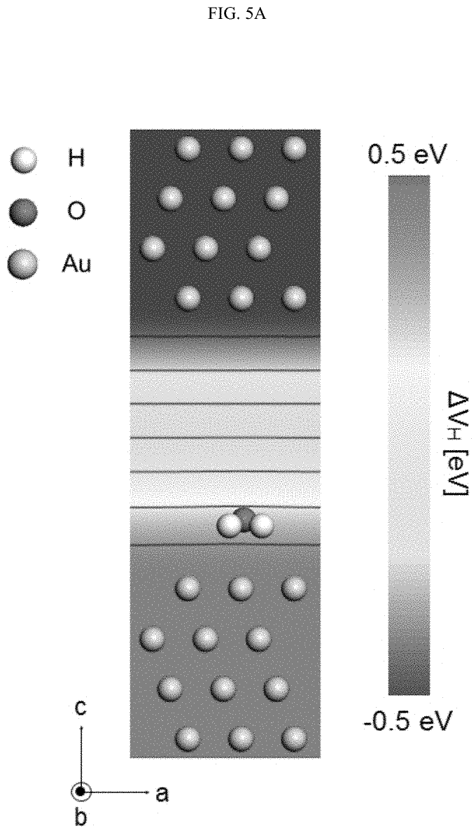

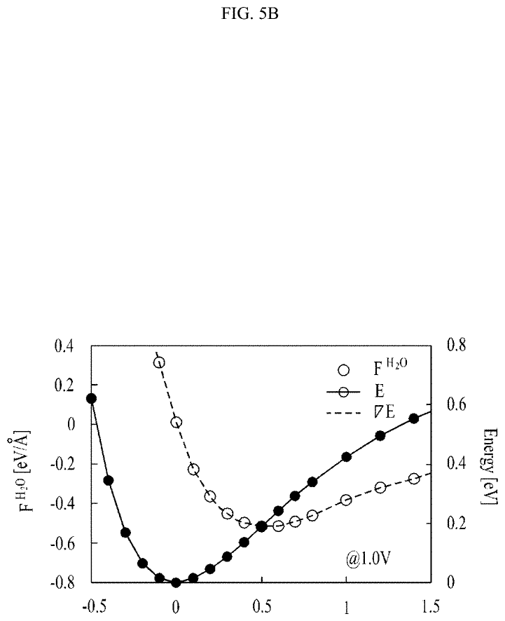

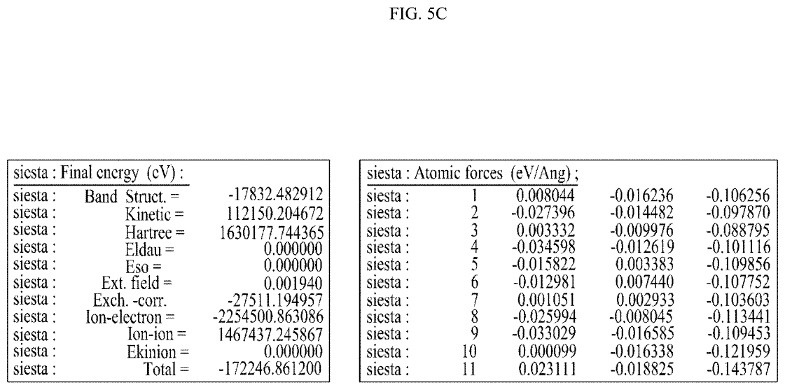

FIGS. 5A to 5C illustrate an exemplary diagram for analysis of non-equilibrium energy and atomic force through a calculation result by a method of the inventive concept and illustrates an exemplary diagram for a method of describing energy and force curves between metal-water molecules in a non-equilibrium state and an output of intrinsic result of an MS-DFT calculation, according to an MS-DFT method proposed in the inventive concept.

Here, FIG. 5A illustrates an atomic model, FIG. 5B illustrates an energy/atomic change curves according to a distance between subjects, and FIG. 5C illustrates a calculation output result.

As illustrated in FIGS. 5A to 5C, the most distinction of the inventive concept from the existing NEGF methodology is that an electronic structure of a device under an applied voltage is variationally calculated by applying a micro-canonical constrained search density functional theory and an exact energy value of a non-equilibrium electronic structure and the force acting on an atom are calculated (see FIG. 5C), which is a specific result and output value of the MS-DFT.

In addition, as illustrated in FIG. 5B, the inventive concept may obtain a gold (Au)-water molecule adsorption energy-distance change curve “E” and a force-distance change curve “∇E” derived from energy curve, through the MS-DFT, and a force-distance change curve “F^{H2O}” acting on water molecules acquired directly through MS-DFT.

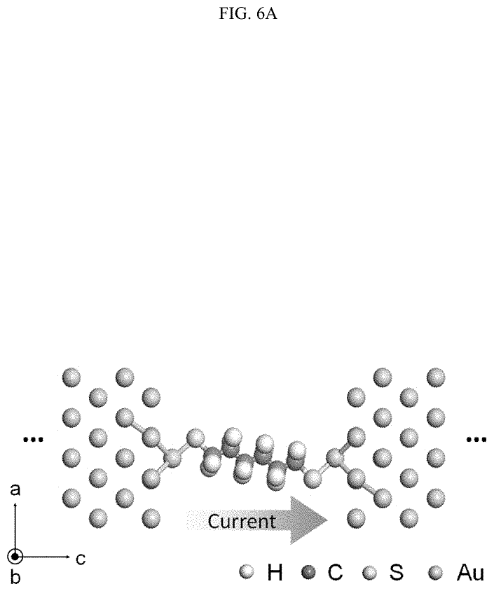

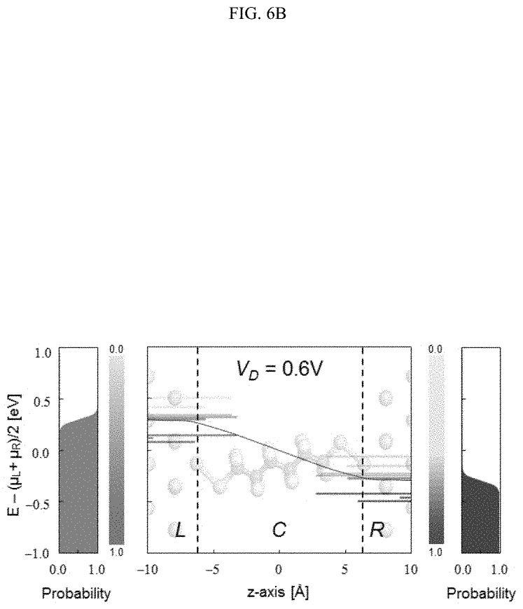

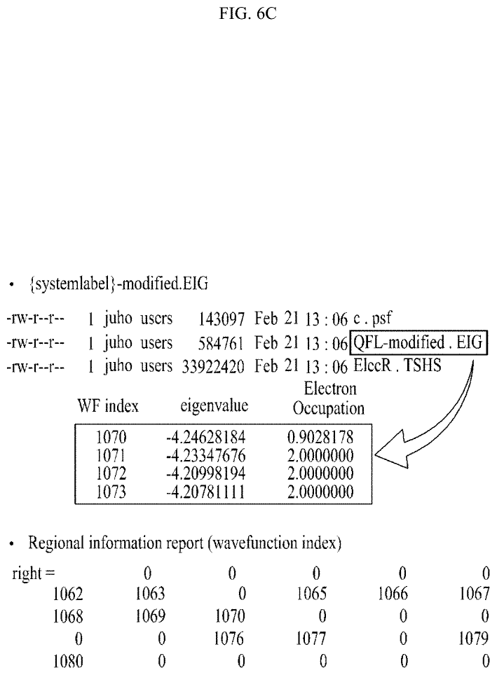

FIGS. 6A to 6C illustrate an exemplary diagram for a method of calculating an electrochemical potential change (quasi-Fermi level profile) using electron occupancy information of an energy level (or wave function) distributed in a channel according to a method of the inventive concept and illustrates an exemplary diagram for a method of describing the occupancy of a wave function in a channel and an output of intrinsic result of an MS-DFT calculation for deriving charge transport characteristics of a non-equilibrium molecular electronic device and another nanodevice system, according to an MS-DFT method proposed in the inventive concept.

Here, FIG. 6A illustrates a molecular junction model, FIG. 6B illustrates an electrochemical potential, and FIG. 6C illustrates a calculation result output.

As illustrated in FIGS. 6A to 6C, the most distinction of the inventive concept from the existing NEGF methodology is that derived electron occupancy and wave function are analyzed together to derive electrochemical potential change (quasi-Fermi level profile) of the device in a non-equilibrium state, which is an MS-DFT-specific result and an output value. In addition, the inventive concept may describe electrical characteristics of a pair of metal electrodes having an infinitely repeated atomic arrangement in a direction of electron conduction and a molecular device consisting of a molecular channel connected to the electrodes through strong chemical bond. In detail, the inventive concept may determine whether the wave function existing at each energy level within a range originates from a left “L”/right “R” electrode to obtain electron occupancy of the wave function distributed in a channel (“C”, center region). In addition, as illustrated in FIG. 6B, a situation in which a voltage of 0.6 V is applied to the molecular device system may be presented.

Furthermore, blue and red lines illustrated in FIG. 6B mean each wave function distributed in an energy space averaged by a plane along a certain axis (z-axis), wave functions indicated in red determine electron occupancy depending on electrochemical potential of the left electrode, wave functions marked in blue determine electron occupancy depending on the electrochemical potential of the right electrode, and it may be seen that color transparency is expressed differently depending on the electronic occupancy. The electron occupancy of the wave function distributed in the central region may be derived based thereon.

In addition, as a result of the MS-DFT calculation illustrated in FIG. 6C, it may be seen that a novel file is created that records the eigenvalue and electron occupation of each wave function. The most distinction of the inventive concept from the existing NEGF methodology is that the electron density is determined by the wave function and the Fermi-Dirac distribution in the inventive concept while the electron density is calculated through the correlation function “Gⁿ” in the NEGF methodology, thereby directly calculating the electronic occupancy of each wave function. Accordingly, the atomic level non-equilibrium electrochemical potential (quasi-Fermi level profile) based on the first principle can be directly provided.

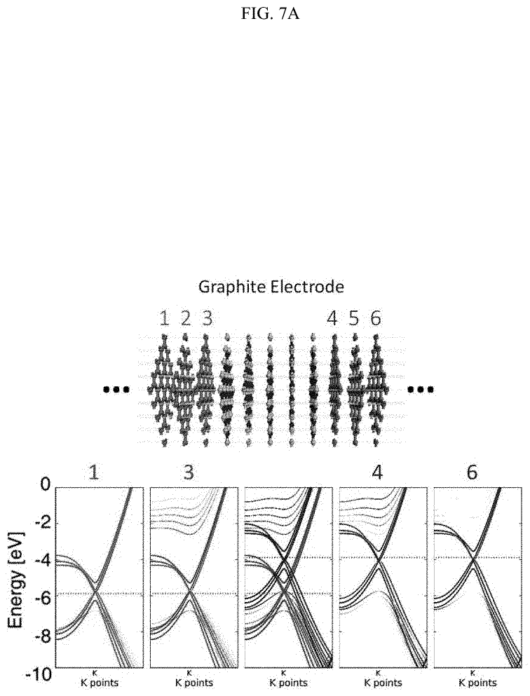

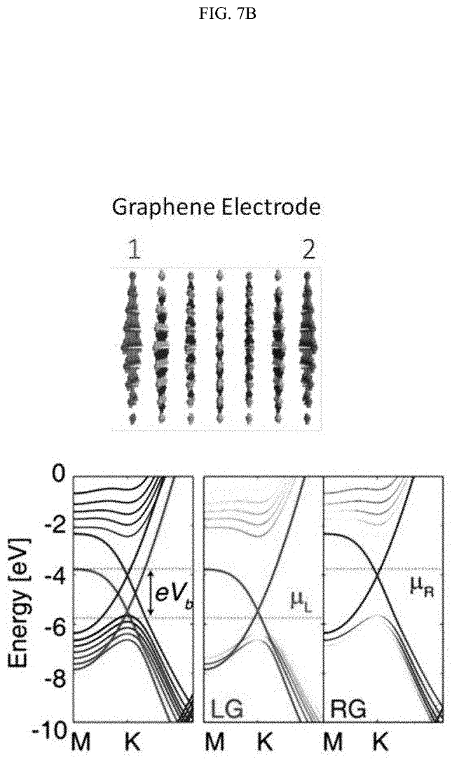

FIGS. 7A and 7B illustrate an exemplary diagram in which an electronic structure in a non-equilibrium state is capable of being described using conventional DFT-based analysis techniques by applying a method of the inventive concept to a two-dimensional stacked nanodevice, FIG. 7A illustrates a graphite “L”-Hexagonal boron nitride (h-BN) “C”-graphite “R” model, and FIG. 7B illustrates a graphene “L”-hexagonal boron nitride (h-BN) “C”-graphene “R” model.

Here, an energy band structure when a voltage of 2.0V is applied may be illustrated and the energy band structure may be analyzed to confirm a change in the electronic structure and hybridization of the electrode depending on the applied voltage.

As illustrated in FIGS. 7A and 7B, the most distinction of the inventive concept from the existing NEGF methodology is that a band structure is calculated based on an eigenvalue of the variationally calculated wave function in a non-equilibrium state, which is a specific result and output value of the MS-DFT.

FIG. 7A is a band structure of a two-dimensional stacked device consisting of a graphite electrode and hBN, a red line shows a band structure of “L” graphite electrode, and a blue line shows a band structure of “R” graphite electrode. It may be seen that graphene (3 and 4 graphene) in an interface layer of hBN and graphite are hybridized and graphene in a bulk region (1 and 6) is not affected by hBN, through band structure analysis.

FIG. 7B is a band structure of a two-dimensional stacked device consisting of a graphene electrode and hBN, a red line shows a band structure of “L” graphene electrode, and a blue line shows a band structure of “R” graphene electrode. It may be seen that graphene (1 and 2) in an interface layer of hBN and graphene are hybridized through band structure analysis.

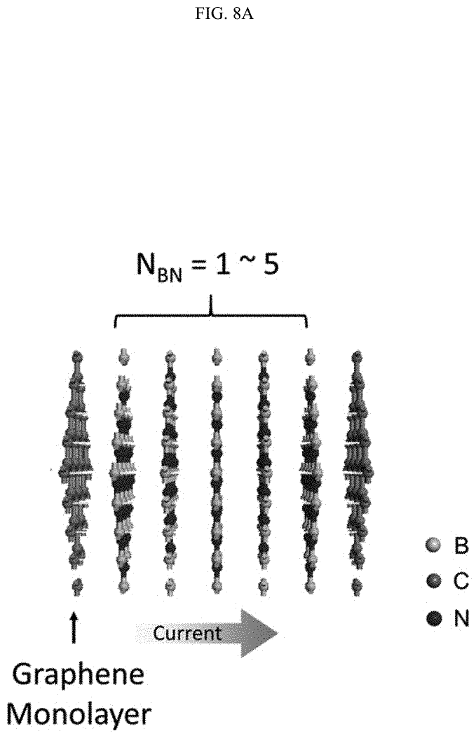

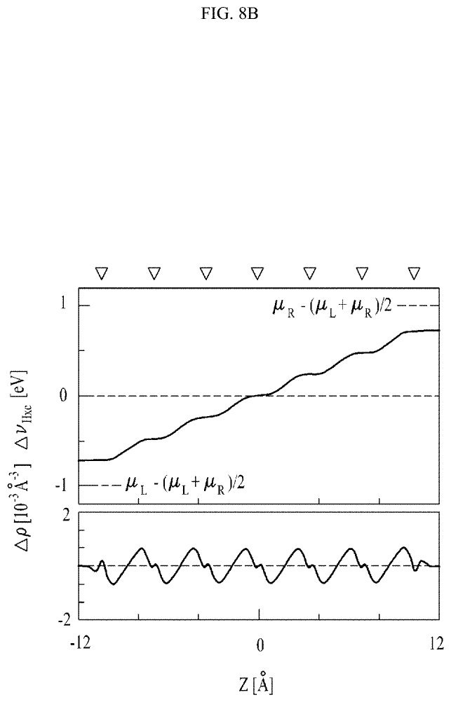

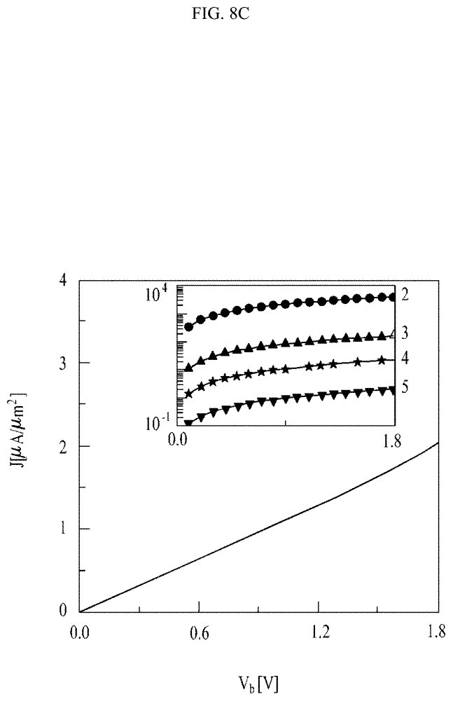

FIGS. 8A to 8C illustrate an exemplary diagram of an non-equilibrium electronic structure and current-voltage characteristics in a two-dimensional stacked device based on a finite dimensional electrode to which a voltage is applied by applying a method of the inventive concept. An MS-DFT method proposed in the inventive concept may be applied to calculate quantum charge transport characteristics of a finite-dimensional electrode-based nanodevice such as graphene shown in FIG. 7B as well as quantum charge transport characteristics of an electrode-based nanodevice indefinitely repeating which is handled in the existing DFT-NEGF like the graphite electrode of FIG. 7A.

FIGS. 8A to 8C are an embodiment for the current-voltage characteristics illustrated in FIG. 4, illustrates a model consisting of graphene “L”-hexagonal boron nitride (h-BN) “C”-graphene “R”, and illustrates an electrostatic potential (FIG. 8B) and the current-voltage characteristics (FIG. 8C) when a voltage of 2.0V is applied.

As illustrated in FIGS. 8A to 8C, the most distinction of the inventive concept from the existing NEGF methodology is that quantum charge transport characteristics of a two-dimensional electrode-based multilayer device having a finite dimension is described, which a specific result and output value of an MS-DFT. In addition, as illustrated in FIG. 8B, the amount of change in the electrostatic potential and charge density in a two-dimensional stacked device using the MS-DFT methodology of the inventive concept when the voltage of 2.0V is applied may be provided. As illustrated in FIG. 8C, a current-voltage curve when an NBN increases may be provided.

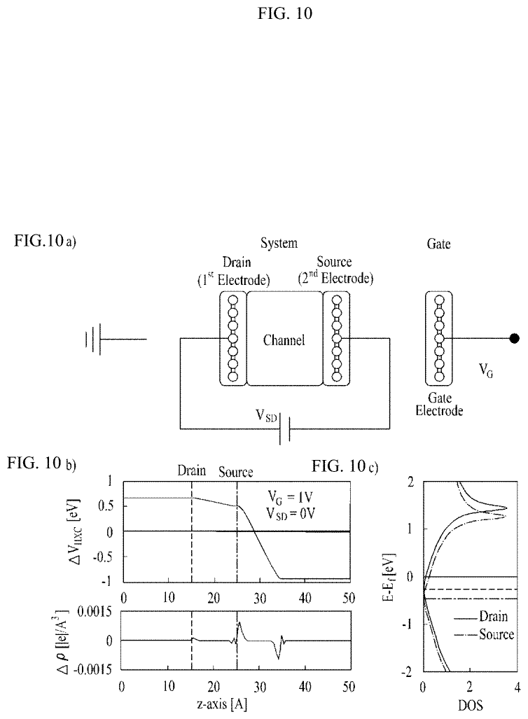

FIGS. 10A to 10C illustrate an exemplary diagram for a technical description embodiment of a multi-electrode using MS-DFT proposed by the inventive concept and a method thereof.

As illustrated in FIGS. 10 to 10C, according to the inventive concept, each generated wave function is classified into each region based on a spatial distribution and a non-equilibrium state may be described using the Fermi-Dirac distribution function based on electrochemical potential defined for each region.

Here, in the process of defining a region, a channel, a first electrode, a the second electrode, or the additional electrode as needed of the nanodevice may be described and when the additional electrode is described, charge neutrality condition and the total number of electrons of an entire computation system may be maintained.

FIG. 10A, which is an atomic structure and schematic diagram of a two-dimensional vertically stacked field-effect transistor (FET) device composed of a graphene single layer electrode and a gate electrode, may describe formation of an N-type or P-type channel due to the gate voltage effect by artificially adjusting electron occupancy between the electronic device and the gate. FIG. 10B illustrates a change in electrostatic potential and charge redistribution when a gate voltage, for example, 1V is applied to a graphene electrode-based two-dimensional vertically stacked FET device. FIG. 10C illustrates an electronic structure analysis derived from a result of FIG. 10B.

As described above, the method according to the embodiment of the inventive concept may simulate a non-equilibrium electronic structure when a voltage is applied based on a variational method without any parameters or assumptions and current voltage characteristics using the same.

In addition, the method according to the embodiment of the inventive concept may secure efficiency of calculation and accuracy based on the variational calculation compared to the existing DFT-based NEGF methodology in performing ECAD at an atomic level and describe electrodes of finite dimensions rather than electrodes of infinite dimensions.

In addition, the method according to the embodiment of the inventive concept may build a noble first principle calculation system that describes a non-equilibrium system having variational characteristics, which overcomes disadvantages of both the existing pure DFT and NEGF, when the non-equilibrium system to which voltage is applied is described.

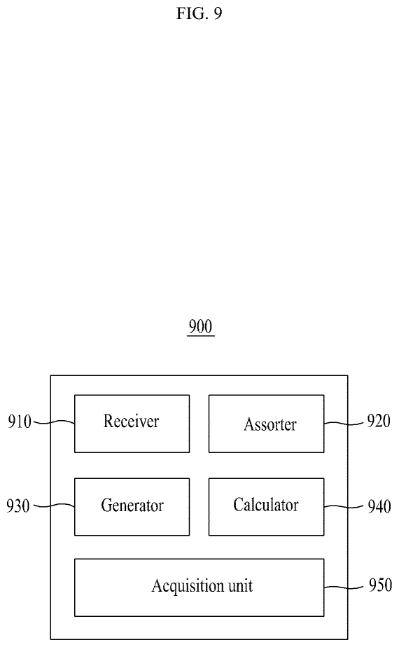

FIG. 9 illustrates a configuration of an apparatus for simulating a non-equilibrium electronic structure of a nanodevice according to an embodiment of the inventive concept and illustrates a conceptual configuration of an apparatus for performing the method of FIGS. 1 to 8.

Referring to FIG. 9, an apparatus 900 according to an embodiment of the inventive concept includes a receiver 910, an assorter 920, a generator 930, a calculator 940, and an acquisition unit 950.

The receiver 910 receives information on each region and applied voltage of a channel, a first electrode, and a second electrode or an additional electrode including a gate electrode as needed of an electronic device based on information on the existing first principle and upper approximation method and information on an atomic structure of the electronic device.

Here, the receiver 910 may receive information on an electrode of the electronic device, for example, information on a semi-infinite electrode or a finite electrode. The information on the atomic structure may include all information on the atomic structure of the inventive concept, such as information on an atom itself, information on an atomic structure, and electronic information on the atom.

The assorter 920 classifies wave functions generated through the existing first principle and upper approximation method into each region of the channel, the first electrode, and the second electrode or the additional electrode as needed of the electronic device based on a spatial distribution method, for example, an LCAO method.

Here, the assorter 920 may generate the wave functions according to the first principle calculation based on the information on the atomic structure and classify the generated wave functions into each region of the channel, the first electrode, and the second electrode of the electric device using coefficients for linear bonds of atomic orbitals included in the generated wave functions.

The generator 930 generates a Fermi-Dirac distribution function depending on electrochemical potential of each of the channel, the first electrode, and the second electrode or the additional electrode as needed based on the classified region information and the applied voltage information.

Here, the generator 930 may calculate the total number of electrons in a non-equilibrium state based on the Fermi-Dirac distribution function depending on the electrochemical potential of each region defined, calculate a difference between the total number of electrons in the non-equilibrium state and the total number of electrons in an equilibrium state, redefine the Fermi-Dirac distribution function depending on the electrochemical potential of each region when the calculated difference is greater than a predetermined reference difference, and define an electrochemical potential and a Fermi-Dirac distribution function of each final region when the calculated difference is less than or equal to the reference difference.

The calculator 940 calculate non-equilibrium electron density of the electronic device using the Fermi-Dirac distribution function depending on the electrochemical potential of the channel, the first electrode, and the second electrode or the additional electrode as needed and the wave functions of each classified region.

Here, the calculator 940 may calculate a difference between the calculated non-equilibrium electron density and a previously calculated non-equilibrium electron density, provide the calculated non-equilibrium electron density to the assorter 920 to be reclassified into each region of the channel, the first electrode, and the second electrode of the electric device when the difference between the calculated non-equilibrium electron density is greater than a predetermined reference difference, and calculate the calculated non-equilibrium electron density as a final non-equilibrium electron density when the difference between the calculated non-equilibrium electron density and a previously calculated non-equilibrium electron density is less than the reference difference.

The acquisition unit 950 acquires the information on the non-equilibrium electronic structure of the electronic device based on the calculated non-equilibrium electron density.

Here, the non-equilibrium electronic structure information acquired by the acquisition unit 950 may include a result of a first principle calculation of the electronic device, non-equilibrium electron density, total energy, eigenstates, that is, wave functions, eigenvalues, quasi-Fermi level, non-equilibrium steady state, Hamiltonian, overlap matrix, electron density matrix, and the like.

Furthermore, the acquisition unit 950 may acquire local electrochemical potential change characteristics of a nanodevice using spatial distribution and electron occupancy information of the wave function distributed in the channel of the nanodevice and information on the non-equilibrium electronic structure which is applied voltage to the nanodevice by applying a first principle calculation analysis method of equilibrium including band structure or state density (DOS).

In addition, the acquisition unit 950 acquires the current-voltage characteristics of the electronic device based on the acquired non-equilibrium electronic structure information.

Here, the acquisition unit 950 may derive a retardation Green's function based on the acquired non-equilibrium electronic structure information, calculate a transmission function based on the derived retardation Green's function, and obtain the current-voltage characteristics of the electronic device by applying the calculated transmission function to the Landauer formula.

Although the description of the device of FIG. 9 is omitted, the device of FIG. 9 may include all the contents described in FIGS. 1 to 8 and 10, and these matters are apparent to those skilled in the art in the technical field of the inventive concept.

According to embodiments of the inventive concept, a non-equilibrium electronic structure of an electronic device when voltage is applied based on a variational method without any parameters or assumptions and current-voltage characteristics using the same may be simulated.

According to embodiments of the inventive concept, when an atomic-level ECAD is performed, efficiency and accuracy of calculation may be secured, compared to the conventional DFT-based non-equilibrium Green's function (NEGF) methodology and a finite-dimensional electrode as well as an infinite-dimensional electrode may be described.

An atomic-level first principle calculation is already playing an important role in research in various applied/engineering fields such as materials, electronics, and medicine, not just basic sciences such as physics, chemistry, and biology due to its versatility and accuracy.

According to embodiments of the inventive concept, in describing a non-equilibrium system to which voltage is applied, a noble first principle calculation system for describing a non-equilibrium system may be constructed, while having a variational characteristic that overcomes the shortcomings of both the existing pure DFT and NEGF. Therefore, non-equilibrium electrical characteristics and electron transport characteristics within a device may be explored at the atomic level to present guidelines for the design and implementation of various next-generation nano electronic devices, energy devices, and bio devices.

The system or apparatus described herein illustrated herein implemented using hardware components, software components, and/or a combination thereof. For example, the systems, devices, and components described herein may be configured using at least one universal computer or special purpose computer, for example, a processor, a controller and an arithmetic logic unit (ALU), a digital signal processor, a microcomputer, a field programmable array (FPA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording media.

As described above, although the inventive concept is described by the limited embodiment and drawings, those skilled in the art will appreciate that various changes and modifications are possible, without departing from this disclosure. Therefore, exemplary embodiments of the inventive concept have not been described for limiting purposes. Accordingly, the scope of the disclosure is not to be limited by the above embodiments but by the claims and the equivalents thereof. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. A method of simulating a non-equilibrium electronic structure of a nanodevice, the method comprising:
receiving region information and applied voltage information of each of a channel, a first electrode, and a second electrode of the nanodevice based on information on a first principle and an upper approximation method and information on an atomic structure of the nanodevice;
classifying wave functions generated through the first principle and upper approximation method into each region of the channel, the first electrode, and the second electrode of the nanodevice based on a spatial distribution;
defining a Fermi-Dirac distribution function depending on an electrochemical potential of each of the channel, the first electrode, and the second electrode based on the classified region information and the applied voltage information;
calculating a non-equilibrium electron density of the nanodevice using the Fermi-Dirac distribution function corresponding to the region information of each of the channel, the first electrode, and the second electrode and the wave functions of the classified regions; and
acquiring non-equilibrium electronic structure information of the nanodevice based on the calculated non-equilibrium electron density.

2. The method of claim 1, wherein the classifying includes generating the wave functions depending on the first principle calculation based on the information on the atomic structure and classifying the generated wave functions into the region of each of the channel, the first electrode, and the second electrode of the nanodevice using coefficients for atomic orbitals included in the generated wave functions.

3. The method of claim 1, wherein the defining of the Fermi-Dirac distribution function includes:
calculating the total number of electrons in a non-equilibrium state based on the Fermi-Dirac distribution function depending on the electrochemical potential of the defined each region;
calculating a difference between the total number of electrons in the non-equilibrium state and the total number of electrons in an equilibrium state;
redefining a Fermi-Dirac distribution function depending on a electrochemical potential of each region when the calculated difference is greater than a predetermined reference difference; and
defining a final electrochemical potential and a final Fermi-Dirac distribution function of each region when the calculated difference is less than or equal to the reference difference.

4. The method of claim 1, wherein the method of simulating the non-equilibrium electronic structure of the nanodevice is performed using the first principle calculation and a tight-binding (TB) method based on the first principle.

5. The method of claim 1, wherein the acquiring of the non-equilibrium electronic structure information further includes:
acquiring local electrochemical potential change characteristics of the nanodevice using information on spatial distribution and electron occupancy of the wave function distributed in the channel of the nanodevice.

6. The method of claim 1, wherein the acquiring of the non-equilibrium electronic structure information further includes:
acquiring information on the non-equilibrium electronic structure to which a voltage of the nanodevice is applied by applying an equilibrium first principle calculation analysis method including a band structure or a density of state (DOS).

7. The method of claim 1, further comprising:
acquiring current-voltage characteristics of the nanodevice including a finite electrode-based nanodevice without additional information on an semi-infinite electrode-based nanodevice and a bulk system corresponding to an electrode based on the acquired non-equilibrium electronic structure information.

8. The method of claim 1, wherein the receiving includes additionally receiving region information on an additional electrode including a gate electrode,
wherein the classifying includes classifying the wave functions into each region of the channel, the first electrode, the second electrode, and the additional electrode,
wherein the defining of the Fermi-Dirac distribution function includes defining a Fermi-Dirac distribution function depending on an electrochemical potential of each of the channel, the first electrode, the second electrode, and the additional electrode, and
wherein the calculating of the non-equilibrium electron density includes calculating a non-equilibrium electron density of the nanodevice using a Fermi-Dirac distribution function corresponding to the region information of each of the channel, the first electrode, the second electrode, and the additional electrode and wave functions of the classified regions.

9. An apparatus for simulating a non-equilibrium electronic structure of a nanodevice, the apparatus comprising:
a receiver configured to receive region information and applied voltage information of each of a channel, a first electrode, and a second electrode of the nanodevice based on information on first principle and upper approximation method and information on an atomic structure of the nanodevice;
an assorter configured to classify wave functions generated through the first principle and upper approximation method into each region of the channel, the first electrode, and the second electrode of the nanodevice based on a spatial distribution;
a generator configured to define a Fermi-Dirac distribution function depending on an electrochemical potential of each of the channel, the first electrode, and the second electrode based on the classified region information and the applied voltage information;
a calculator configured to calculate a non-equilibrium electron density of the nanodevice using the Fermi-Dirac distribution function corresponding to the region information of each of the channel, the first electrode, and the second electrode and the wave functions of the classified regions; and
an acquisition unit configured to acquire non-equilibrium electronic structure information of the nanodevice based on the calculated non-equilibrium electron density.

10. The apparatus of claim 9, wherein the assorter generates the wave functions depending on the first principle calculation based on the information on the atomic structure and classifies the generated wave functions into the region of each of the channel, the first electrode, and the second electrode of the nanodevice using coefficients for atomic orbitals included in the generated wave functions.

11. The apparatus of claim 9, wherein the generator:
calculates the total number of electrons in a non-equilibrium state based on the Fermi-Dirac distribution function depending on the electrochemical potential of each region defined;
calculates a difference between the total number of electrons in the non-equilibrium state and the total number of electrons in an equilibrium state;
redefines a Fermi-Dirac distribution function depending on a electrochemical potential of each region when the calculated difference is greater than a predetermined reference difference; and
defines a final electrochemical potential and a final Fermi-Dirac distribution function of each region when the calculated difference is less than or equal to the reference difference.

12. The apparatus of claim 9, wherein the apparatus for simulating the non-equilibrium electronic structure of the nanodevice is performed using the first principle calculation and a tight-binding (TB) method based on the first principle.

13. The apparatus of claim 9, wherein the acquisition unit acquires local electrochemical potential change characteristics of the nanodevice using information on spatial distribution and electron occupancy of the wave function distributed in the channel of the nanodevice.

14. The apparatus of claim 9, wherein the acquisition unit acquires information on the non-equilibrium electronic structure to which a voltage of the nanodevice is applied by applying an equilibrium first principle calculation analysis method including a band structure or a density of state (DOS).

15. The apparatus of claim 9, wherein the acquisition unit acquires current-voltage characteristics of the nanodevice including a finite electrode-based nanodevice without additional information on a semi-infinite electrode-based nanodevice and a bulk system corresponding to an electrode based on the acquired non-equilibrium electronic structure information.

16. The apparatus of claim 9, the receiver additionally receives region information on an additional electrode including a gate electrode,
wherein the assorter classifies the wave functions into each region of the channel, the first electrode, the second electrode, and the additional electrode,
wherein the generator defines a Fermi-Dirac distribution function depending on an electrochemical potential of each of the channel, the first electrode, the second electrode, and the additional electrode, and
wherein the calculator calculates a non-equilibrium electron density of the nanodevice using a Fermi-Dirac distribution function corresponding to the region information of each of the channel, the first electrode, the second electrode, and the additional electrode and wave functions of the classified regions.
